(19) United States
(12) Patent Application Publication
(10) Pub. No.: US 2023/0015853 A1
(43) Pub. Date: Jan. 19, 2023

(54) SENSOR ELEMENTS FOR A CUTTING TOOL AND METHODS OF MAKING AND USING SAME

(71) Applicant: Element Six (UK) Limited, Didcot, Oxfordshire (GB)

(72) Inventor: Christopher John Howard Wort, Didcot (GB)

(73) Assignee: Element Six (UK) Limited, Didcot, Oxfordshire (GB)

(21) Appl. No.: 17/784,807

(22) PCT Filed: Dec. 29, 2020
(86) PCT No.: PCT/EP2020/087975

§ 371 Date: Jun. 13, 2022

(30) Foreign Application Priority Data
Dec. 31, 2019 (GB) 1919482.8

(51) Int. Cl. E21B 47/013; G01L 1/18; E21B 49/00; E21B 10/567

(52) U.S. Cl. CPC E21B 47/013; G01L 1/18; E21B 49/003; E21B 10/567

(57) ABSTRACT

A sensor element for a cutting tool, the sensor element having a hard portion having a working surface and at least one diamond crystal at least partially embedded in the hard portion, the at least one diamond crystal being arranged to generate a piezoresistive signal in response to the working surface engaging external material in use.

### FIELD

The present disclosure generally relates to sensor elements for use on or in connection with a cutting tool for earth-boring tools such as drill bits, to earth-boring tools including such sensing elements, and to methods of making and using such sensor elements and tools.

### BACKGROUND

In the oil and gas industry, cutting tools such as downhole drill bits, including roller cone bits and fixed cutter bits, are designed and manufactured to minimize the probability of catastrophic drill bit failure during drilling operations. During drilling operations the loss from a drill bit of a roller cone, or a polycrystalline diamond compact acting as a cutter element therein can impede the drilling and may necessitate an expensive and time consuming operation to retrieve the bit or components thereof from the wellbore before catastrophic damage to the drill bit itself occurs.

Conventionally, logging while drilling (LWD) and measuring while drilling (MWD) measurements are obtained from measurements behind the drill head and are therefore off-set from the drill bit itself and the cutting elements therein. While a number of sensors and measurement systems may record information near the earth-boring drill bit, conventional polycrystalline diamond (PCD) cutting elements used in earth-boring drill bits do not provide measurements directly at the drill bit. This off-set of the sensors may contribute to errors in measurements that relate directly to the condition of the cutting elements.

Drill bits used for boring into the earth for oil or gas exploration typically include arrays of PCD cutter elements, which are driven against rock deep beneath the earth's surface to cut through rock formations. In such operations, a bit may need to bore through several types of geological formations and an operator may wish to have an indication of the formation currently being bored.

There is a need for operators of cutting tools to gain insight into certain characteristics of workpiece material being cut. In particular, but not exclusively, operators of earth-boring bits may benefit from having near real-time indication of characteristics of rock in a formation being drilled.

In drilling operations, a cutting element, also termed an insert, is subjected to heavy loads and high temperatures at various stages of its useful life. In the early stages of drilling, when the sharp cutting edge of the insert contacts the subterranean formation, it is subjected to large contact pressures. This results in the possibility of a number of fracture processes such as fatigue cracking being initiated. As the cutting edge of the insert wears, the contact pressure decreases and is generally too low to cause high energy failures. However, this pressure can still propagate cracks initiated under high contact pressures and may eventually result in spalling-type failures. In the drilling industry, PCD cutter performance is determined by a cutter's ability to achieve high penetration rates in increasingly demanding environments, and still retain a good condition post-drilling (enabling re-use if desired). In any drilling application, cutters may wear through a combination of smooth, abrasive type wear and spalling/chipping type wear. Whilst a smooth, abrasive wear mode is desirable because it delivers maximum benefit from the highly wear-resistant PCD material, spelling or chipping type wear is unfavourable. Even fairly minimal fracture damage of this type can have a deleterious effect on both cutting life and performance.

Cutting efficiency may be rapidly reduced by spalling-type wear as the rate of penetration of the drill bit into the formation is slowed. Once chipping begins, the amount of damage to the diamond table continually increases, as a result of the increased normal force required to achieve a given depth of cut. Therefore, as cutter damage occurs and the rate of penetration of the drill bit decreases, the response of increasing weight on bit may quickly lead to further degradation and ultimately catastrophic failure of the chipped cutting element.

PCD cutting elements are typically provided with a theoretical usable lifetime which may be predicted in terms of, for example, time, number of metres cut, number of drilling operations and the like. However, as chipping is a brittle process, the performance of any individual cutting element may greatly exceed that of another individual cutting element, and this effect is difficult to predict which may have an impact on the actual useable lifetime of any individual cutting element.

There is therefore a need to be able to detect parameters during use of the cutting element such as chipping, and wear scar size, and to measure or predict cutting element life more accurately during operation, leading to less risk of damaging the drill bits or tools into which the cutting elements are inserted and also to obtain information relating to performance or behaviour of a drill bit and related components whilst the drill bit is being used as this may be useful for characterising and evaluating the durability, performance and potential failure of the drill bit or components thereof.

### SUMMARY

According to a first version there is provided a sensor element for a cutting tool comprising:
a hard portion having a working surface; and
at least one diamond crystal at least partially embedded in the hard portion, the at least one diamond crystal being arranged to generate a piezoresistive signal in response to the working surface engaging external material in use.

According to a second version there is provided a cutter element for an earth-boring drilling tool, the cutter element comprising the sensor element defined above, the at least one diamond crystal being configured to generate a piezoresistive signal when the cutting element is drilling a borehole in use.

According to a third version there is provided an earth-boring tool, comprising:
a body;
at least one cutting element as defined above attached to the body; and
a data acquisition module configured to receive the piezoresistive signal from the at least one diamond crystal.

According to a fourth version there is provided a method of using the above defined cutter element comprising:
engaging a workpiece body with the cutter element to remove workpiece material from the workpiece body, and allowing the working surface of the sensor element to engage external material containing workpiece material;
generating a piezoresistive signal to flow from the any one or more diamond crystals; and
analysing the piezoresistive signal to determine a characteristic of the external material.

According to a fifth version there is provided a method of forming a sensor element for a cutting tool comprising:
at least partially embedding at least one diamond crystal in a hard portion having a working surface; the at least one diamond crystal being arranged to generate a piezoresistive signal in response to the working surface engaging external material in use, the piezoresitive signal being indicative of a characteristic of the external material.

Various example methods and systems are envisaged by this disclosure, of which various non-limiting, non-exhaustive examples and variations are described as follows.

### BRIEF DESCRIPTION OF THE DRAWINGS

Non-limiting example arrangements to illustrate the present disclosure are described with reference to the accompanying drawings, in which:

FIG. 1 is a schematic drawing of an example sensor assembly;

FIG. 2 is a schematic cross-sectional view through an example sensor element;

FIG. 3 is a schematic cross-sectional view through a portion of an example sensor element;

FIG. 4 is a schematic cross-sectional view through a further example sensor element in use;

FIG. 5 is a schematic cross-sectional view through a further example sensor element; and

FIG. 6 is a schematic partly perspective and partly cut-away views of an example earth-boring bit, including a sensor element configured as a cutting element mounted on the bit.

### DETAILED DESCRIPTION

Referring in general to the following description and accompanying drawings, various versions of the present disclosure are illustrated to show its structure and method of operation. Common elements of the illustrated examples are designated by the same reference numerals.

Certain terms as used herein will be briefly explained:

As used herein, “hard” material has a Knoop hardness of at least about 1000 kg·mm⁻². A hard material may include polycrystalline hard material comprising grains of hard material cemented together by a relatively softer material. Examples of hard material may include silicon carbide, silicon nitride, alumina and cemented tungsten carbide (which may be referred to as “hard-metal”).

As used herein, “super-hard” material has a load-independent Vickers hardness of at least about 28 GPa; some super-hard materials may have a load-independent Vickers hardness of at least about 30 GPa, or at least about 40 GPa. As used herein, Vickers hardness is according to the ASTM384-08a standard.

Some example super-hard materials may include polycrystalline super-hard material comprising grains of super-hard material cemented together by a relatively softer material; or in which a substantial fraction of the super-hard grains are directly bonded to each other (for example, intergrown), potentially including interstitial regions between the super-hard grains. Interstitial regions may include non-super-hard filler material, and/or interstitial regions may include voids. Examples of super-hard material may include single crystal diamond, polycrystalline diamond (PCD), cubic boron nitride (cBN), polycrystalline cBN (PCBN), diamond produced by chemical vapour deposition (CVDD), or diamond grains cemented by a hard material such as silicon carbide.

A super-hard polycrystalline material may comprise an aggregation of a plurality of super-hard grains such as diamond or cBN grains, a substantial portion of which may be directly inter-bonded and may include interstitial regions among the super-hard grains. The interstitial regions may contain non-super-hard filler material such as metal in elemental or alloy form, ceramic material or intermetallic material, for example. The filler material may bind the super-hard grains together, and/or at least partially fill the interstitial regions. The content of the super-hard grains in super-hard polycrystalline material may be at least about 50 volume %, or at least about 70 volume %, or at least about 80 volume %; and/or at most about 97 volume %, or at most about 95 volume %, or at most about 90 volume % of the polycrystalline material.

As used herein, polycrystalline diamond (PCD) material comprises a plurality of diamond grains, a substantial portion of which are directly inter-bonded with each other or contact each other at grain boundaries. Polycrystalline diamond may consist essentially of diamond grains or include non-diamond material or voids. In some PCD material, the diamond grains may account for at least 80% of the volume of PCD material, substantially all the remaining volume being a network of interstitial regions among the diamond grains. The interstitial regions may be partly or entirely filled with diamond sintering aid material, or other filler material, or at least some of the interstitial regions may contain voids. Sintering aid for diamond may also be referred to as “catalyst material” for promoting the growth of diamond grains or the formation of diamond necks between adjacent diamond grains, under thermodynamically stable conditions for diamond. Catalyst material for diamond may also function as solvent material for carbon, and diamond sintering aid material may also be referred to as “solvent/catalyst” material. Examples of solvent/catalyst materials for diamond include iron (Fe), nickel (Ni), cobalt (Co) and manganese (Mn), and certain alloys including at least one of these elements. PCD material may be produced by subjecting an aggregation of diamond grains to an ultra-high pressure (for example, at least about 6 GPa) and a high temperature (for example, at least about 1,200° C.) in the presence of molten solvent/catalyst material. During the HPHT process, solvent/catalyst material may infiltrate through the interstitial regions among the diamond grains from an adjacent source, such as a Co-cemented tungsten carbide substrate. Consequently, PCD material may comprise the inter-bonded diamond grains and interstitial regions containing Co. Some polycrystalline diamond material consisting essentially of diamond may be manufactured by a chemical vapour deposition (CVD) process.

As used herein, “electrically conductive” may include (doped or undoped) semiconductor materials, including doped wide-bandgap semiconductor materials such boron- or phosphorus-doped diamond.

As used herein, a “workpiece body” means a body, or a portion of a body, being processed by a tool to remove material from the body. For example, a workpiece may include a rock formation in the earth, or a body of raw material processed by a machine tool.

As used herein, swarf may comprise chips (or “cuttings”) of material removed from a workpiece or rock formation by means of a cutter element, and/or other debris generated by a cutting or other material removal process. In various examples, swarf may consist essentially of chips, or swarf may comprise other materials present in the cutting environment, such as lubricant and/or flushing and/or cooling fluid, which may include bubbles (in other words, swarf may include one or two fluid phases). For example, swarf arising from an earth-boring process may comprise slurry material, including rock chips, fragments of rock, sand and water. Swarf may include particles of cutting tool material, arising from abrasion or erosion of the cutting tool.

As used herein, a “rake face” is a surface area of a cutter element, over which chips of workpiece material will flow, when the cutter element is used to cut a workpiece.

As used herein, “drill bit” means and includes any type of bit or tool used for drilling during the formation or enlargement of a wellbore in subterranean formations and includes, for example, fixed cutter bits, rotary drill bits, percussion bits, core bits, eccentric bits, bi-center bits, reamers, mills, drag bits, roller cone bits, hybrid bits and other drilling bits and tools known in the art.

As used herein, a “superhard construction” means a construction comprising a body of polycrystalline superhard material. In such a construction, a substrate may be attached thereto or the body of polycrystalline material may be free-standing and unbacked.

Cutter elements for use in drill bits in the oil and gas industry typically comprise a layer of polycrystalline diamond (PCD) bonded to a cemented carbide substrate. PCD material is typically made by subjecting an aggregated mass of diamond particles or grains to an ultra-high pressure of greater than about 5 GPa, and temperature of at least about 1200° C., typically about 1440° C., in the presence of a sintering aid, also referred to as a solvent-catalyst material for diamond. Solvent-catalyst materials for diamond are understood to be materials that are capable of promoting direct inter-growth of diamond grains at a pressure and temperature condition at which diamond is thermodynamically more stable than graphite.

As mentioned above, examples of solvent-catalyst materials for diamond are cobalt, iron, nickel and certain alloys including alloys of any of these elements.

The term “substrate” as used herein means any substrate over which the superhard material layer is formed. For example, a “substrate” as used herein may be a transition layer formed over another substrate.

The superhard construction shown in the figures may be suitable, for example, for use as a cutter insert for a drill bit for boring into the earth. Such an earth-boring drill bit (not shown) includes a plurality of cutting elements, and typically includes a bit body which may be secured to a shank by way of a threaded connection and/or a weld extending around the earth-boring drill bit on an exterior surface thereof along an interface between the bit body and the shank. A plurality of cutting elements are attached to a face of the bit body, one or more of which may comprise a cutting element as described herein in further detail below.

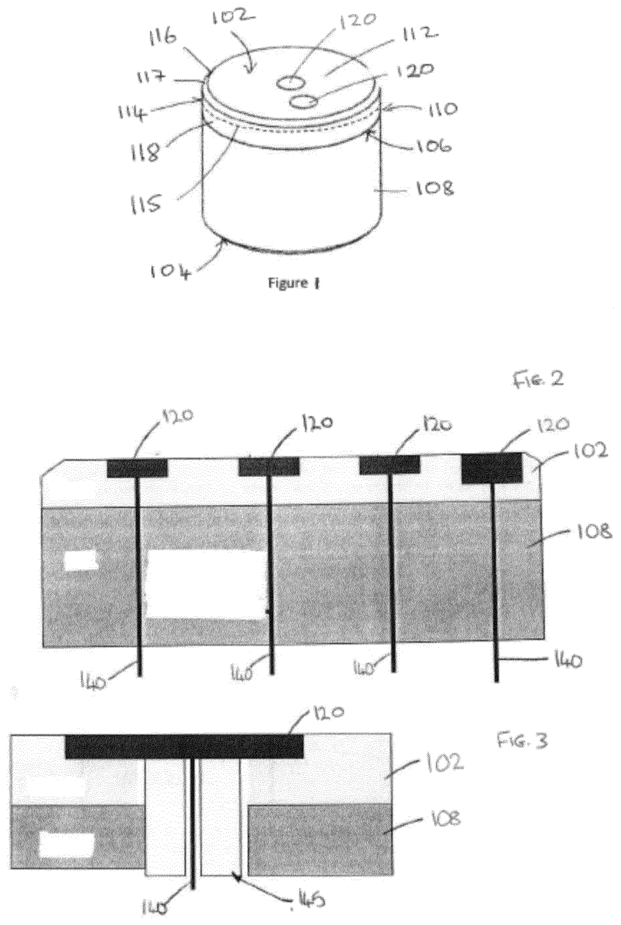

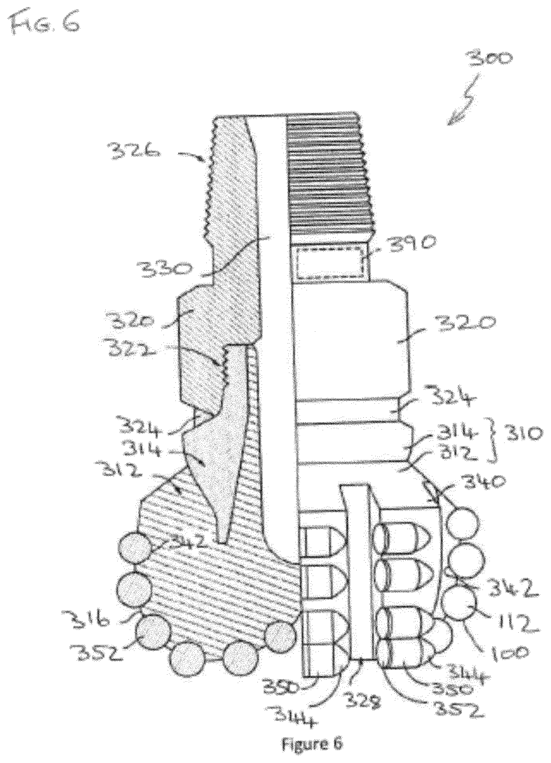

FIG. 1 shows a first example sensor element for use in a drill bit of the type described above. With reference to FIGS. 1 to 5, example sensor elements may be configured as cutter elements for an earth-boring bit (100 as shown in FIG. 6). An example sensor element may have a proximal end 102 and a distal end 104, connected by a substantially cylindrical side 103. The sensor elements may comprise a hard portion 110 joined to a substrate portion 108, in which the hard portion 110 may comprise polycrystalline diamond (PCD) material and the substrate portion 108 may comprise cobalt-cemented tungsten carbide (Co—WC) material, joined to the hard portion 110 at an interface boundary 106. The hard portion 110 has a working surface 112, a major area of which is coterminous with the proximal end 102, opposite the interface boundary 106, the working surface 112 including a circumferential cutting edge 116 coterminous with a chamfer area 117. The working surface 112 may extend over all or part of the proximal end 102 and, in some examples, along all or part of the side 103 of the sensor element.

In some examples, the PCD material comprised in the hard portion 110 may include a first PCD volume 114 and a second PCD volume 118. The first PCD volume 114 may be electrically insulating and the second PCD volume 118 may be electrically conducting and include cobalt. The second PCD volume 118 may be coterminous with the interface boundary 106 with the substrate portion 108, located remotely from the working surface 112, while the first PCD volume 114 may be coterminous with the working surface 112 and may extend to a boundary 115 with the second PCD volume 118. The hard portion 110 may have a thickness of about 2 mm to about 3 mm, from the working surface 112 to the interface boundary 106; and the first PCD volume 114 may have a mean thickness of about 100 microns to about 500 microns, from the working surface 112 to an interface boundary 115 with the second PCD volume 118.

PCD material comprises an aggregated plurality of directly inter-grown diamond grains and a plurality of interstitial regions between diamond grains (not visible in FIG. 1). The interstitial regions in the second PCD volume 118 may be filled with filler material comprising cobalt, which had infiltrated from the substrate portion 108 during the process of sintering the diamond grains against the substrate portion 108. A substantial portion of the cobalt (and/or other electrically conducting material) that had been present in the first PCD volume 114 might have been removed from the interstitial regions by treating the first PCD volume in acid, to leach out metallic material. The first PCD volume 114 may include interstitial voids and less than about 2 wt. % of cobalt, or substantially no cobalt. Consequently, the first PCD volume 114 is an electrically insulating portion 114 and the second PCD volume 118 may be electrically conducting. In other examples, the hard portion 110 may comprise a single volume which may or may not comprise residual solvent catalyst such as cobalt in interstitial spaces between, for example, interbonded diamond grains in the example where the hard portion comprises polycrystalline diamond (PCD) material.

In the examples where the hard portion 110 comprises PCD, the PCD material may be, for example, formed of diamond grains that are of natural and/or synthetic origin.

A plurality of diamond crystals 120 are embedded in the working surface 112 of the hard portion 110. One or both of the diamond crystals 120 may comprise, for example, boron-doped diamond, which may be deposited in or on the working surface 112 using, for example, a chemical vapour deposition technique. One or more diamond crystals 120 may be substantially cylindrical in shape, having an axial length of about 0.1 mm to about 2 mm (for example, about 0.5 mm) and a diameter of about 0.5 mm to about 5 mm (for example, about 2 mm). A wide range of shapes and arrangements of the crystals 120 are envisaged, including cubic, rhombohedral, prismatic and polygonal shapes. In some examples, an exposed surface of one or both crystals 120 may be substantially coplanar with an adjacent area of the working surface 112 or may be recessed from the working surface 112. In some examples, a sensor element may have any number of diamond crystals such as two or, for example, four crystals or may be a plurality of diamond crystals such as a polycrystalline diamond material.

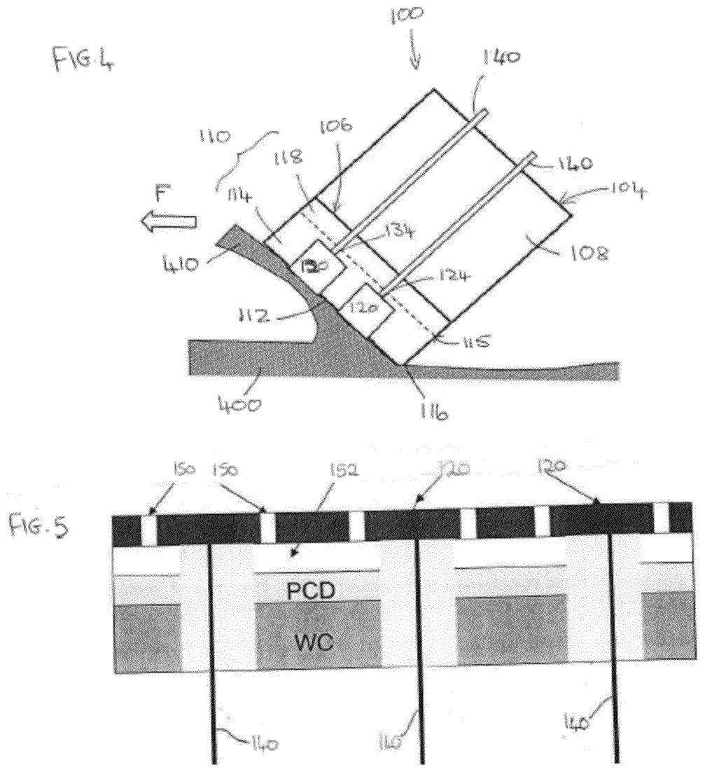

As shown in FIG. 2, respective through-holes may extend from the bottom of these diamond crystals 120 to the distal end 104, each through-hole housing respective wires 140. A respective proximal end of each wires 140 may be brazed to respective diamond crystals 120. As shown in FIG. 3, the wires 140 may be housed within a respective electrically insulating sheath 145, to electrically isolate them from the hard portion 110 and from the substrate portion 108. Respective distal ends of the wires 140 may extend beyond the distal end 104 of the sensor element, or be guided by the through-holes to emerge from a side or the base of the sensor element. Each wire 140 thus provides a respective electrically conducting connection between the respective crystals 120 and distal ends of the wires 140, which may have terminals (not shown) for connecting the wires 140 to a measurement device.

The distal ends of the wires 140 may be electrically connected to respective devices to allow the temperatures and/or pressures at the working surface of the diamond crystals 120 to be measured in use when the sensor element contacts the external material 400, 410 being processed as shown in FIG. 4.

The example sensor assembly illustrated in FIG. 5 shows an alternative configuration in which the diamond crystals 120 are spaced from the hard portion 110 by a region of intrinsic diamond material 152. The diamond crystals may additionally spaced from adjacent diamond crystals 120 by, for example, a mesa etch 150.

The example sensor assemblies illustrated in FIGS. 1 to 5 may additionally include a computer system communicatively connected to the wires 140, allowing the computer system to receive data indicative of, for example, the temperature of each diamond crystal 120 and/or pressure detected as being applied to the diamond crystals 120 during use. The computer system may comprise an executable computer program, configured to process the received data to determine the characteristics of the external material (410 in FIG. 4) when the sensor element is in use. The computer program may have access to various other data, such as properties of various kinds of rock formations and other materials such as water and/or oil, as well as various relationships between measurable parameters.

Based on a piezoresistive response of the diamond crystal sensors 120, information relating to the performance of the cutter, such as thermal and mechanical data may be obtained such as stresses and pressures. Although cutters are illustrated and described herein as exemplary, other versions of the present disclosure may include other components within the drill bit being configured for obtaining information related to the drill bit diamond sensors that exhibit a piezoresistive response.

Furthermore, the term “embedded” as used herein is intended to mean that the diamond crystals 120 may be positioned in or on the working surface of the hard portion 110. In some examples, the diamond sensors (diamond crystals) 120 are embedded before the cutter is sintered and finished. In other examples, the diamond crystals 120 are embedded during or after sintering, processing and finishing. The sensors 120 may be formed from a diamond material, comprising one or more diamond crystals and may be referred to as a diamond sensor 120. The cutting element may be formed at least partially of polycrystalline diamond material (PCD).

The diamond sensors 120 may be configured for providing environmental information such as temperature and/or pressure during the rock cutting process. Diamond sensors 120 may include a single crystal diamond or a polycrystalline diamond material comprising a plurality of diamond crystals. The diamond material may be natural or synthetic single crystal diamond materials. The diamond sensors 120 may be configured to generate a piezoresistive signal in response to an applied stimulus (e.g., mechanical stresses, pressure, temperature, etc.). Generally, the piezoresistive signal may be an electrical voltage having a known relationship to an applied stimulus, such as pressure or temperature. The diamond sensors 120 may be spatially distributed on the cutting element and may have non-uniform sizes, depths, aspect ratios and/or crystallographic orientations.

An example method of using an example sensor assembly 200, mounted onto an example earth-boring bit 300, will be described with reference to FIGS. 1 to 6. With particular reference to FIG. 6, an example cutting tool may comprise a fixed-cutter type of earth-boring bit 300, for use in oil and gas exploration, and an example sensor element 100 may be implemented as a cutter element for the earth-boring bit 300. The earth-boring bit may comprise a bit body 310, including a crown 312 and a steel blank 314. The steel blank 314 may be partially embedded in the crown 312, which may be formed of tungsten carbide grains embedded in a copper alloy matrix material. The bit body 312 has a bit face 316 and a plurality of blades 340, arranged azimuthally about a longitudinal axis defined by a longitudinal bore 330 and spaced apart from each other by junk slots 328. The bit body 310 may be secured to a steel shank 320 by way of a threaded connection 322 and a weld 324, which extends around the drill bit 300 on an exterior surface, along an interface between the bit body 310 and the steel shank 320. The steel shank 320 may have a threaded connection portion 326 for attaching the drill bit 300 to a drill string (not shown), which may include a tubular pipe and segments coupled end to end between the earth-boring drill bit 300 and other drilling equipment at the surface of the earth. Internal fluid passageways (not shown) may extend between the bit face 316 and the longitudinal bore 330, which extends through a steel shank 320 and partially through the bit body 310. Nozzle inserts (not shown) may also be provided at the bit face 316 within the internal fluid passageways.

As mentioned above, the example sensor elements may be configured as cutter elements for an earth-boring bit and each cutter element 350, 100 may have a substantially cylindrical shape and comprise a hard portion 110 formed of PCD and a substrate portion 108 formed of cobalt-cemented tungsten carbide attached to the hard portion 110, each hard portion 110 having a respective cutting surface 352, 112. A plurality of cutter elements 350, including the sensor element 100, may be attached at the bit face 316, in which a part of the substrate portion 108 of each cutter element 350, 100 may be brazed within a respective pocket 342 provided in the bit face 316. In some examples, the substrate portion 108 of a sensor element 100 may include an attachment portion adjacent the distal end 104, inserted into a pocket 342. Each cutter element 350, 100 may be supported from behind by a respective buttress 344, which may be integrally formed with the crown 312.

In some example arrangements, the earth-boring bit 300 may include a data collection module 390, to which the wires 140 may be electrically connected. The data collection module 390 may include components (not shown) such as an analogue-to-digital converter, a computer processor, executable software and other components for collecting and/or interpreting data generated by the sensor element 100 in use.

In operation, electrical signals representative of an applied stimulus such as pressure or temperature from the diamond crystals 120 transmitted through conductive pathways 140, may convey the signals to the data collection module 390. Such data transmission may include wired or wireless communication. A processing module may be located, for example, within the drill bit itself for further processing of the data.

During drilling operations, the earth-boring bit 300 may be positioned at the bottom of a bore hole (not shown) such that the cutter elements 350, 100 are adjacent the earth formation 400 (in FIG. 7) to be drilled, and the earth-boring bit 300 is driven to rotate within the bore hole. As the earth-boring bit 300 is rotated, drilling fluid is pumped to the bit face 316 through the longitudinal bore 330 and the internal fluid passageways (not shown). Rotation of the drill bit 100 causes the cutter elements 350, 100 to scrape across and shear away material 410 at the surface of the underlying rock formation 400. Swarf 410 including chips (which may also be referred to as cuttings) of the rock formation 400 combined with, and/or suspended within, the drilling fluid is generated by the earth boring operation. As the earth-boring bit 300 rotates, the cutter elements 350, 100 can shear away material from the surface of the formation 400, generating a significant amount of heat and mechanical stress within the cutter elements 350, 100.

The swarf 410 can pass through the junk slots 328 and an annular space (not shown) between the bore hole and the drill string and move to the surface of the earth.

FIG. 5 shows an example sensor element 100 implemented as a cutter element 100 for an earth-boring bit 300 (in FIG. 6), cutting material from an underlying rock formation 400. The sensor element 100 is illustrated in cross-section, showing example first and second diamond crystals 120 and respective wires 140 brazed onto each of the crystals 120. The sensor element 100 comprises a PCD hard portion 110 and a substrate portion 108 comprising Co—WC material, the hard portion 110 and substrate portions 108 joined to each other at an interface boundary 106. The PCD hard portion 110 comprises an electrically insulating first PCD volume 114 that is coterminous with the working surface 112, and an electrically conducting second PCD volume 118 that is remote from the working surface 112. In some examples, the crystals 120 may comprise doped diamond such as boron-doped diamond, and these may be housed within respective pockets in the first PCD volume 114 or be attached to the working surface 112.

As the earth boring bit 300 drives the example sensor element 100 in a direction F by the (in FIG. 4), a cutting edge 116 of the sensor element 100 cuts rock from the rock formation, generating swarf material 410 including one or more rock chip as well as water and/or oil. The swarf 410 may contact the working surface 112, at least an area of which functioning as a rake face 11, guiding the swarf away from the cutting edge 116. The PCD material comprised in the hard portion 110 will be highly resistant to abrasive or erosive wear by rock chips passing over the working surface 112. In addition, the diamond crystal(s) 120 will also be highly wear resistant.

An indication of certain characteristics of the swarf 410 and potentially the underlying rock formation 400 may be obtained as, in general, the electrical properties of a doped diamond crystal acting as a sensing element may depend on its temperature and/or on the compressive force applied to it. For example, the electrical resistivity of the boron-doped diamond may change dependent on a compressive force applied to it. The resistivity of boron-doped diamond depends on the level of boron dopant concentration and the temperature. Boron-doped diamond also exhibits a piezoresistive response.

Some example methods of using an example sensor element 100 may include determining a change in the material composition of rock 400 or other material 400 being cut. This information may be conveyed to an operator, to allow them to modify operating parameters dependent on characteristics of the workpiece material 400. For example, if the sensor element 100 is attached to an earth-boring bit 300, measurement of electrical characteristics of the rock 400, and/or of swarf 410 containing chips of rock, may indicate whether the earth-boring bit 300 is boring through an oil-containing formation 400. The indicated characteristics of the external material 410, 400 may change substantially when the earth-boring bit 300 moves from water-containing to oil-containing formation 400, or vice versa. The measurement may indicate a magnitude of porosity of the formation 400 and the load on the earth-boring bit 300 may be modified dependent on this information. The measurement may indirectly indicate the compressive strength, or other mechanical characteristic, of the formation 400.

An example method of making an example sensor element 100 of any one or more of FIGS. 1 to 5, configured as a cutter element for an earth-boring bit 300, will be described.

A precursor body comprising a PCD portion joined to a cobalt-cemented tungsten carbide (Co—WC) substrate portion may be manufactured by means of an ultra-high pressure, high temperature (HPHT) process. An HPHT process may include placing an aggregation of diamond grains onto the Co—WC substrate, providing a pre-sinter assembly (not shown), and subjecting the pre-sinter assembly to a pressure of at least about 6 GPa and a temperature of at least about 1,250° C. In some example processes, the aggregation of diamond grains may include catalyst material such as Co, in powder form or as deposited microstructures on the diamond grains. The Co within the substrate and potentially within the aggregation of diamond grains will melt, infiltrate into interstitial regions among the diamond grains under capillary action and promote the direct inter-growth of neighbouring diamond grains. When the pressure and temperature are decreased to ambient conditions, the Co (or alloy including Co, for example) will solidify, providing a precursor body comprising the layer of PCD material 110 joined to the substrate portion 108, from which the sensor element 100 can be formed (as used herein, ambient or atmospheric pressure is about 1.0 MPa and ambient temperature is about 20° C. to about 40° C.).

The precursor body may be substantially cylindrical, having a proximal end 102 and a distal end 104, in which the PCD layer 110 is coterminous with the proximal end 102 and the substrate portion 108 is coterminous with the distal end 104. The precursor body may be processed by grinding the PCD layer 110 to form a cutting edge 116 and, in some examples, one or more chamfer 117 adjacent the cutting edge 116. The PCD layer 110 may be treated with acid to remove Co from interstitial regions among the diamond grains within a first PCD volume 114, coterminous with the working surface 112, using a process referred to as acid leaching. After acid leaching, the interstitial regions within the first PCD volume 114 may contain no more than about 2 wt. % Co, rendering the first PCD volume 114 substantially electrically insulating. The second PCD volume 118, in which the interstitial regions are still filled with Co-containing metal, may remain non-leached and extend from an interface boundary 115 with the first PCD volume 114 to the interface boundary 106 between the PCD hard portion 110 and the substrate portion 108.

The diamond crystals 120 may be deposited on or in the hard portion 110 by, for example, a chemical vapour deposition technique.

In some examples, the cemented carbide substrate 104 may be formed of tungsten carbide particles bonded together by the binder material, the binder material comprising an alloy of any one or more of Co, Ni and Cr. The tungsten carbide particles may form at least 70 weight percent and at most 95 weight percent of the substrate.

After sintering, the PCD construction was subjected to further treatment to remove the canister material and to shape the construction to the desired cutting element shape and size.

In the example of FIGS. 1 to 5, the channels into which the wires 140 are to be introduced may be formed by conventional techniques such as electric discharge machining (EDM), grinding, spark eroding, or using a laser or other similar methods to create one or more channels in the hard portion 110 in a region spaced from but adjacent the cutting edge 116 and extending through the substrate 104. These channels may be formed, for example, after the sintering process of the cutting element, or in a pre-formed substrate before sintering with the diamond grains to form the cutting element, or in situ through inclusion of a plug that is removed after sintering.

At least one diamond crystal (sensing element) 120 may be integrated into the bulk of the hard portion 110 during the sintering process or formed by Chemical Vapour Deposition (CVD) of the diamond crystal(s) after the processing of the PCD. In some examples, the diamond crystal(s) may be in the form of a disc of boron-doped diamond (either poly or monocrystalline), or a layered structure incorporating bands of boron-doped and intrinsic diamond, having a diameter of, for example, between around 0.5 mm to around 5 mm, which may be sintered into the bulk PCD matrix during the fabrication process used to form the hard portion 110.

Electrical contact to the diamond crystals 120 may be made via a wire 140 inserted through a through-hole in the substrate 104 and the hard portion 110, to the diamond sensing element. As described above, the hole or channel(s) may be drilled before or after the sintering process and the wire attached to the sensor element(s) 120 before or after the sintering process. The wire may be brazed to the diamond crystal using, for example, a high temperature reactive braze.

In some examples, during the sintering process, the diamond sensor element(s) 120 may be fused into the bulk matrix of the hard portion 110 which may be, for example a PCD material, thus mechanically integrating the sensing element 120.

The insulated wires 140 may be incorporated either during the sintering process used to form the hard portion 110, or added post sintering.

In use, in some examples, the piezoresistance is measured between the insulated wire and the PCD which forms the other connection.

In an alternative method, a Chemical Vapour Deposition (CVD) process may be used to deposit the diamond crystals 120 onto the surface of a pre-sintered and processed hard portion 110. In some examples, an electrically insulating CVD diamond layer may be deposited onto the PCD surface, which may be leached prior to the CVD diamond deposition to provide electrical isolation, and then a boron-doped CVD diamond layer may be deposited onto the intrinsic layer. The boron-doped CVD diamond layer may then be patterned into, for example small electrically isolated regions by a known technique such as laser cutting, ion beam milling or hot metal dissolution.

Electrical contact to the sensor regions 120 may be made via wires 140 extending through holes drilled through the substrate, through the PCD and the intrinsic CVD diamond layers to electrically contact the rear surface of the boron-doped diamond sensor region. The contacts may be made via brazed wires or simple pressure contacts. The sensors regions may be used as individual sensors (for example as piezoresistors for pressure sensing or thermistors for temperature sensing) or in pairs (for basic electrical conductivity).

In the example shown in FIG. 5, the hard portion 110 (for example a PCD layer) may have a thickness of for example between around 0.3 mm to around 1 mm, and the thicknesses of the intrinsic diamond regions and the doped diamond regions may be for example around 10 microns. The sensing regions 120 may be isolated by mesa etching down to the intrinsic layer 152.

In some examples, refractory metal wires (such as WC wires) 140 may be incorporated within the diamond matrix during sintering to form a PCD hard portion 110, the wires protruding through holes (which may be electrically insulated) in the substrate 104. After sintering, residual catalyst binder in the hard portion 110 may be removed using conventional PCD leaching techniques leaving electrically insulating PCD with conducting wires running through it. This may then be coated with boron-doped CVD diamond and the sensor regions 120 fabricated and used as above. (Note: The advantage of this technique is that the boron-doped diamond would be in intimate contact with the wires running through the PCD so no brazing is required.

Example sensing elements such as those shown in FIGS. 1 to 5 may be used to measure the pressure of the sensing element during operation simply by measuring the change in electrical resistivity of the boron-doped diamond as the pressure changes, the diamond crystals 120 acting as a piezoresistors. By using different boron concentrations, different diamond dopants and/or different sensor geometries other key parameters may be sensed such as temperature or electrical conductivity. For example, the construction of FIG. 5 may be used, in particular, to measure other properties such as electrical conductivity of the drilling environment.

A wide range of configurations and arrangements of the diamond crystals 120 is envisaged.

Whilst not wishing to be bound by theory, boron-doped diamond has a very large piezoresistive coefficient compared to other materials (orders of magnitude higher than metals for example) and that, when combined with its robustness in harsh environments a boron-doped diamond pressure sensing element may be particularly suitable for inclusion into a cutter element for drilling applications.

The piezoresistivity of boron-doped diamond depends not only upon the boron concentration but also the temperature of operation, with higher piezoresistive coefficients (so-called gauge factors) being obtained with higher doping concentrations at elevated temperatures (where the boron is fully activated). Single crystals of diamond doped with high boron concentrations may be used in some examples, as a pressure sensing element; however, doped high quality polycrystalline diamond may also be used in other examples. Diamond single crystals doped with boron may be produced by conventional CVD and HPHT techniques and doped polycrystalline diamond may be produced by, for example, a known CVD technique.

A high doping of boron in the diamond may be considered to be, for example, boron doping levels in excess of 1×10E20 per cc. This level of doping may be achieved in CVD diamond by adding boron (via diborane gas) into the synthesis process.

In summary, example sensor elements for a cutting tool comprise a hard portion 110 having a working surface 112 and at least one diamond crystal 120 at least partially embedded in the hard portion, the at least one diamond crystal 120 being arranged to generate a piezoresistive signal in response to the working surface engaging external material in use.

The at least one diamond crystal may comprise any one or more of a single diamond crystal, polycrystalline diamond material, or a plurality of diamond crystals.

The at least one diamond crystal 120 may be doped with a dopant material such as any one or more of boron, phosphorous or sulphur.

The piezoresistive signal may be indicative of, for example, an applied pressure.

The hard portion 110 may comprise a polycrystalline diamond material bonded to a substrate 104 along an interface opposing the working surface 112.

In some examples, one or more regions of intrinsic diamond 152 may be included, the one or more diamond crystals 120 being spaced from an adjacent one of said one or more diamond crystals nd/or the hard portion 110 by said region(s) of intrinsic diamond.

The example sensor elements may be configured as a cutter element; the working surface including a cutting edge and providing a rake face area.

In some examples, in particular where the hard portion comprises PCD material, the hard portion may be treated to have a surface volume that includes no more than 2 wt. % metallic material such as residual catalyst binder.

When configured as a cutter element for an earth-boring drilling tool, the cutter element comprising the example sensor elements described herein, the at least one diamond crystal may be configured to generate a piezoresistive signal when the cutting element is drilling a borehole in use.

In some examples, such cutting elements may have a generally cylindrical shape. In other examples, the cutting elements be a different shape, such as conical, or ovoid.

In some examples, the hard portion 110 may be formed as a standalone object, that is, a free-standing unbacked body of material such as PCD material, and may be attached to a substrate 104 in a subsequent step.

It will therefore be seen that various versions of the present disclosure include sensor elements which may, for example, be in the form of cutting elements, and methods of forming same for earth-boring drill bits which may provide an indication of characteristics of the material being worked by cutting elements that is obtained directly from locations at the drill bit to which they are mounted and used. The sensor elements may be used to identify real-time information which may assist in reducing the risk of loss or damage to the cutting elements and/or the earth-boring drill bit to which the cutting elements are mounted.

Although the foregoing description contains many specifics, these are not to be construed as limiting the scope of the present disclosure, but merely as providing certain exemplary versions. For example, whilst boron-doped diamond has been used to describe how the sensing elements would sense pressure or temperature, other dopants could also be used, such as phosphorous or sulphur, either of which may allow higher temperature sensing than, for example, boron doped diamond.

1. A sensor element for a cutting tool, the sensor element comprising:
a hard portion having a working surface; and
at least one diamond crystal at least partially embedded in the hard portion, the at least one diamond crystal being arranged to generate a piezoresistive signal in response to the working surface engaging external material in use.

2. The sensor element of claim 1, wherein the at least one diamond crystal comprises a single diamond crystal.

3. The sensor element of claim 1, wherein the at least one diamond crystal comprises polycrystalline diamond material.

4. (canceled)

5. The sensor element of claim 1, wherein the at least one diamond crystal is doped with a dopant material.

6. The sensor element of claim 5, wherein the dopant is any one or more of boron, phosphorous or sulphur.

7. The sensor element of claim 1, wherein the piezoresistive signal is indicative of an applied pressure.

8. The sensor element of claim 1, wherein the hard portion comprises polycrystalline diamond material.

9. The sensor element of claim 1, further comprising a substrate bonded to the hard portion along an interface opposing the working surface.

10. (canceled)

11. The sensor element of claim 1,
further comprising a conductive pathway in communication with the at least one diamond crystal.

12. The sensor element of claim 11, wherein the electrical pathway extends through the hard portion and is insulated therefrom.

13. The sensor element of claim 1, further comprising one or more regions of intrinsic diamond, the one or more diamond crystals being spaced from an adjacent one of said one or more diamond crystals and/or from the hard portion by said region(s) of intrinsic diamond.

14. The sensor element of claim 1, wherein the at least one diamond crystal comprises chemical vapour deposited diamond.

15. (canceled)

16. The sensor element as claimed in claim 1, wherein the hard material portion comprises polycrystalline diamond (PCD) material and includes a surface volume that includes no more than 2 wt. % metallic material.

17. The sensor element of claim 1, configured as a cutting element, the at least one diamond crystal being configured to generate a piezoresistive signal when the cutting element is drilling a borehole in use.

18. An earth-boring tool, comprising:
a body;
at least one sensor element configured as the cutting element of claim 17 attached to the body; and
a data acquisition module configured to receive the piezoresistive signal from the at least one diamond crystal.

19. A method of using a sensor element as claimed in claim 17 comprising:
engaging a workpiece body with the cutter element to remove workpiece material from the workpiece body, and allowing the working surface of the sensor element to engage external material containing workpiece material;
generating a piezoresistive signal to flow from the any one or more diamond crystals; and
analysing the piezoresistive signal to determine a characteristic of the external material.

20. A method as claimed in claim 19, including a computer-implemented method to process the measured piezoresistive signal, to calculate the characteristic of the external material; and to calculate a quantity indicative of a mechanical characteristic of the workpiece material, based on the characteristic.

21. A method of forming a sensor element for a cutting tool comprising:
at least partially embedding at least one diamond crystal in a hard portion having a working surface; the at least one diamond crystal being arranged to generate a piezoresistive signal in response to the working surface engaging external material in use, the piezoresitive signal being indicative of a characteristic of the external material.

22. The method of claim 21, further comprising forming the sensor element at least partially of a polycrystalline diamond material.

23. The method of claim 21, further comprising applying a HPHT synthesis cycle to the sensor element after the at least one diamond crystal is embedded in the hard portion.

24. The method of claim 23, further comprising forming a cutting edge on the sensor element after the HPHT synthesis.

25. The method of claim 21, wherein the step of embedding the at least one diamond crystal comprises depositing the at least one diamond crystal in or onto the working surface using chemical vapour deposition.

26. (canceled)
